(19) United States
(12) Patent Application Publication
(10) Pub. No.: US 2017/0355303 A1
(43) Pub. Date: Dec. 14, 2017

(54) BRAKE LIGHT ASSEMBLY

(71) Applicant: Luis Reyes, Garden Grove, CA (US)

(72) Inventor: Luis Reyes, Garden Grove, CA (US)

(21) Appl. No.: 15/619,396

(22) Filed: Jun. 9, 2017

Related U.S. Application Data
(60) Provisional application No. 62/348,007, filed on Jun. 9, 2016.

(51) Int. Cl. B60Q 1/50; F21S 8/10; B60Q 1/26; B60Q 1/44

(52) U.S. Cl. CPC B60Q 1/503; B60Q 1/441; F21S 48/215; F21S 48/2218; B60Q 1/268; B60Q 1/2696; B60Q 2400/50

(57) ABSTRACT

An improved brake light assembly is a brake light with a housing and internal light emitting diodes for attachment in the back window of a vehicle that illuminates when the brake pedal is depressed. When the Light Emitting Diodes are illuminated, the words “No Texting” are formed.

### CROSS-REFERENCE TO RELATED APPLICATION

The present application is related to and claims priority from prior provisional application Ser. No. 62/348,007, filed Jun. 9, 2016 which application is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

### 1. Field of the Invention

The present invention relates generally to the field of automobile brake lights and more specifically relates to an improved brake light assembly.

### 2. Description of the Related Art

Every day, thousands of consumers across the country are involved in automobile accidents. Ranging in degree from the mild “fender benders” where those involved walk away unscathed, to serious pileups where one or more persons ends up permanently disabled or in worse case scenarios, loses their life, an automobile accident can be a traumatic, life-altering experience. Automobile accidents are so prevalent in this country, that according to recent statistics compiled by the United States Department of Transportation (USDOT), an average of 6.4 million accidents involving passenger automobiles, light trucks, freight trucks, buses and motorcycles occur every year. Of those 6.4 million accidents, an average of 3.2 million people sustain serious injury, while an estimated 42,000 accidents end in fatalities. As tragic and unbelievable as it may seem, every 13 minutes, someone dies in an automobile accident.

As many police officers, patrolmen, paramedics, and doctors will agree, the majority of these accidents are avoidable. Caused by a variety of factors including road conditions, failure to obey traffic signs or signals, and exterior distractions such as flashing road signs, many of these accidents could be avoided if the driver was paying close attention to the road ahead. Because of the rise in cellular phone usage, use of these electronic devices is an increasingly common distraction which can result in an avoidable accident occurring. In fact, according to a recent study compiled by the Virginia Tech Driving Institute, distraction caused by dialing a cell phone increases the risk of accident driving incidents by 2.8 times. Distraction caused by cell phone text messaging while driving increases the risk of accidents driving incidents by 23.2 times in comparison to normal driving conditions. In addition, recent data compiled by the Washington Post found that 342,000 accidents are caused annually by people being distracted by cell phones while driving. This also results in 2,600 fatalities and 43 billion each year in property damage, lost wages, medical bills and fatalities. Simply stated, cell phone users are up to four times more likely to be in a traffic accident than one who is driving without such a distraction. A solution is needed.

Various attempts have been made to solve the above-mentioned problems such as those found in U.S. Pat. No. 5,648,756 to Zadok; U.S. Pat. No. 4,928,084 to Reiser; and U.S. Pat. No. 7,834,752 to Kuvantrarai. This art is representative of messaging devices. None of the above inventions and patents, taken either singly or in combination, is seen to describe the invention as claimed.

Ideally, an automobile brake light should provide illumination and messaging, and yet, would operate reliably and be manufactured at a modest expense. Thus, a need exists for a reliable improved brake light assembly to avoid the above-mentioned problems.

### BRIEF SUMMARY OF THE INVENTION

In view of the foregoing disadvantages inherent in the known automobile brake light art, the present invention provides a novel improved brake light assembly. The general purpose of the present invention, which will be described subsequently in greater detail, is to provide illumination and messaging.

The improved brake light assembly for use with an automobile may comprise a casing having a front surface and a back surface that form an interior volume with the casing adapted to be attached to a rear window of the automobile, a plurality of light emitting diodes electrically connected to one another and located within the interior volume that are adapted to display an image through the front surface, and a power source adapted to supply electrical power to the plurality of light emitting diodes. At least one resistor is located within the interior volume and electrically connected to the plurality of light emitting diodes.

The casing is preferably formed from translucent plastic having a red color and the plurality of light emitting diodes are adapted to emit a red colored light. The casing further includes a reflecting film within the interior surface of the interior volume. The casing may be formed having dimensions of 15 inches in length, 1 inch in width, and 1 inch in depth. A connector member is attached to the casing that is adapted to connect the improved brake light assembly to the rear window of the automobile.

The image displayed by the plurality of light emitting diodes forms the words “No Texting”. The power source is adapted to supply power to the plurality of light emitting diodes when the brake pedal is pushed within the automobile.

The combination of an automobile and an improved brake light assembly for use with the automobile may comprise an automobile including a rear window, a brake pedal, a power source, and a power cable. The power cable is electrically connected between the power source and the brake pedal and is adapted to be electrically connected to the improved brake light assembly. The improved brake light assembly for use with an automobile may comprise a casing having a front surface and a back surface with the front surface and the back surface forming an interior volume and the casing attaches to the rear window of an automobile. A plurality of light emitting diodes are electrically connected to one another and located within the interior volume that are adapted to display an image through the front surface.

The power source supplies electrical power to the plurality of light emitting diodes. At least one resistor is located within the interior volume and is electrically connected to the plurality of light emitting diodes. The light emitting diodes are adapted to emit a red colored light and the casing is formed from a red translucent plastic. The casing further includes a reflecting film within an interior surface of the interior volume. The casing may be formed having dimensions including 15 inches in length, 1 inch in width, and 1 inch in depth. A connector member is attached to the casing and is adapted to connect the improved brake light assembly to the rear window of the automobile. The image displayed by the light emitting diodes forms the words “No Texting”. The power source is adapted to supply power to the plurality of light emitting diodes when a brake pedal is pushed within the automobile.

The present invention holds significant improvements and serves as an improved brake light assembly. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, improved brake light assembly, constructed and operative according to the teachings of the present invention.

FIG. 1 shows a perspective view illustrating an improved brake light assembly according to an embodiment of the present invention.

FIG. 2 is a front view illustrating the improved brake light assembly according to an embodiment of the present invention of FIG. 1.

FIG. 3 is a side see-through view illustrating the improved brake light assembly according to an embodiment of the present invention of FIG. 1.

The various embodiments of the present invention will hereinafter be described in conjunction with the appended drawings, wherein like designations denote like elements.

### DETAILED DESCRIPTION

As discussed above, embodiments of the present invention relate to automobile brake lights and more particularly to an improved brake light assembly as used to improve the illumination and messaging.

Generally speaking, an improved brake light assembly is a brake light with a housing and internal light emitting diodes for attachment in the back window of a vehicle that illuminates when the brake pedal is depressed. When the Light Emitting Diodes are illuminated, the words “No Texting” are formed.

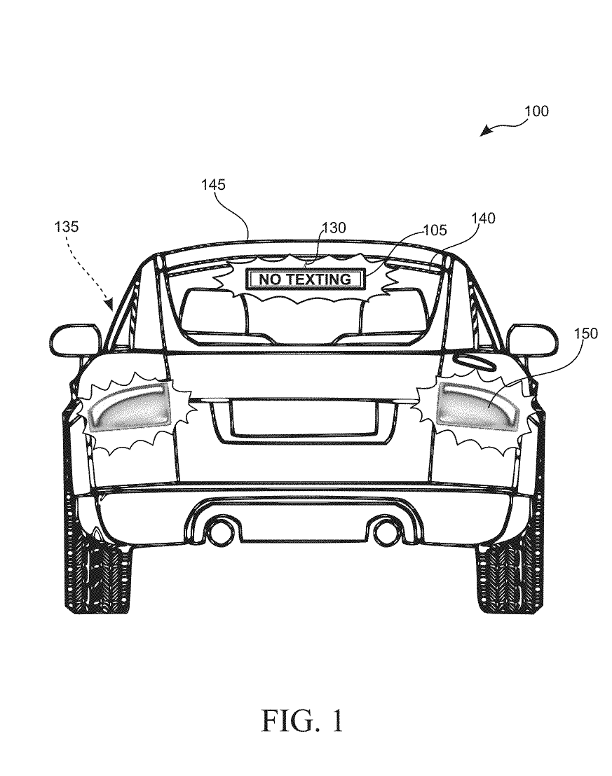

In greater detail now, referring to the drawings by numerals of reference there is shown in FIG. 1, a perspective view illustrating improved brake light assembly 100 according to an embodiment of the present invention.

Improved brake light assembly 100 for use with automobile 145 may comprise casing 105 having front surface 106 and back surface 107 that form interior volume 108 with casing 105 adapted to be attached to rear window 140 of automobile 145, a plurality of light emitting diodes 110 electrically connected to one another and located within interior volume 108 that are adapted to display an image through front surface 106, and power source 115 adapted to supply electrical power to the plurality of light emitting diodes 110.

Casing 105 is preferably formed from translucent plastic having a red color and the plurality of light emitting diodes 110 are adapted to emit a red colored light. Casing 105 further includes a reflecting film within interior surface 109 of interior volume 108. Casing 105 may be formed having dimensions of 15 inches in length, 1 inch in width, and 1 inch in depth. Connector member 125 is attached to casing 105 that is adapted to connect improved brake light assembly 100 to rear window 140 of automobile 145.

The image displayed by the plurality of light emitting diodes 110 forms the words “No Texting”. Power source 115 is adapted to supply power to the plurality of light emitting diodes 110 when the brake pedal is pushed within automobile 145.

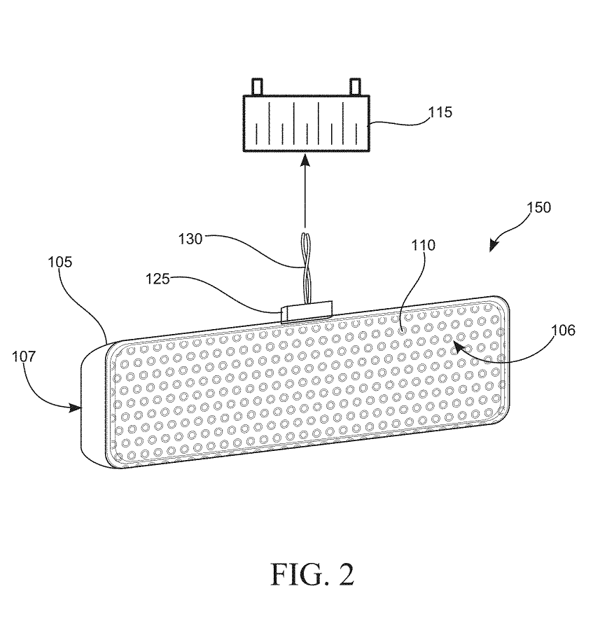

Referring now to FIG. 2, is a front view illustrating improved brake light assembly 100 according to an embodiment of the present invention of FIG. 1.

The combination of automobile 145 and improved brake light assembly 100 for use with automobile 145 may comprise automobile 145 including rear window 140, brake pedal 135, power source 115, and power cable 130. Power cable 130 is electrically connected between power source 115 and brake pedal 135 and is adapted to be electrically connected to improved brake light assembly 100. Improved brake light assembly 100 for use with automobile 145 may comprise casing 105 having front surface 106 and back surface 107 with front surface 106 and back surface 107 forming interior volume 108 and casing 105 attaches to rear window 140 of automobile 145. A plurality of light emitting diodes 110 are electrically connected to one another and located within interior volume 108 that are adapted to display an image through front surface 106.

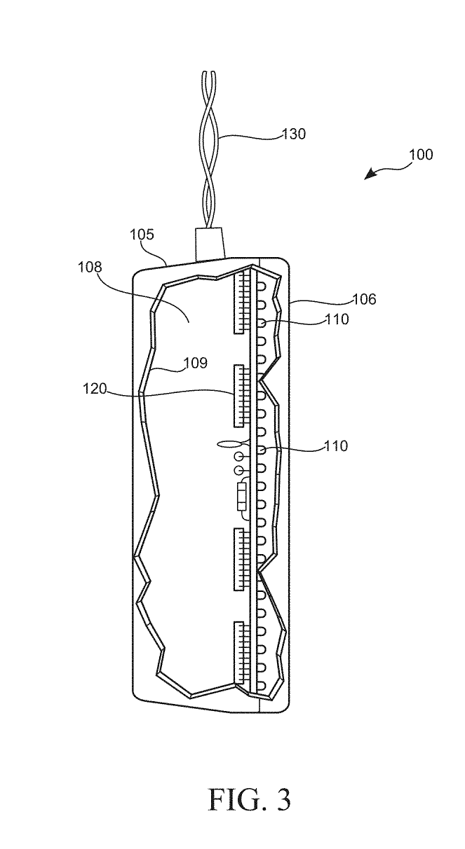

Referring now to FIG. 3, is a side see-through view illustrating improved brake light assembly 100 according to an embodiment of the present invention of FIG. 1.

At least one resistor 120 is located within interior volume 108 and electrically connected to the plurality of light emitting diodes 110. Power source 115 supplies electrical power to the plurality of light emitting diodes 110. At least one resistor 120 is located within interior volume 108 and is electrically connected to the plurality of light emitting diodes 110. Light emitting diodes 110 are adapted to emit a red colored light and casing 105 is formed from a red translucent plastic. Casing 105 further includes a reflecting film within interior surface 109 of interior volume 108. Casing 105 may be formed having dimensions including 15 inches in length, 1 inch in width, and 1 inch in depth. Connector member 125 is attached to casing 105 and is adapted to connect improved brake light assembly 100 to rear window 140 of automobile 145. The image displayed by light emitting diodes 110 forms the words “No Texting”. Power source 115 is adapted to supply power to the plurality of light emitting diodes 110 when brake pedal 135 is pushed within automobile 145.

Improved brake light assembly 100 may be manufactured and provided for sale in a wide variety of sizes and shapes for a wide assortment of applications. Upon reading this specification, it should be appreciated that, under appropriate circumstances, considering such issues as design preference, user preferences, marketing preferences, cost, structural requirements, available materials, technological advances, etc., other kit contents or arrangements such as, for example, including more or less components, customized parts, different color combinations, parts may be sold separately, etc., may be sufficient.

Upon reading this specification, it should be appreciated that, under appropriate circumstances, considering such issues as design preference, user preferences, marketing preferences, cost, structural requirements, available materials, technological advances, etc., other methods of use arrangements such as, for example, different orders within above-mentioned list, elimination or addition of certain steps, including or excluding certain maintenance steps, etc., may be sufficient.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application

What is claimed is new and desired to be protected by Letters Patent is set forth in the appended claims:

1. An improved brake light assembly for use with an automobile, comprising:
a casing including:
a front surface; and
a back surface;
wherein said front surface and said back surface form an interior volume; and wherein said casing is adapted to be attached to a rear window of said automobile;
a plurality of light emitting diodes;
wherein said plurality of light emitting diodes are electrically connected to one another and located within said interior volume and are adapted to display an image through said front surface; and
a power source;
wherein said power source is adapted to supply electrical power to said plurality of light emitting diodes.

2. The improved brake light assembly of claim 1, further comprising at least one resistor located within said interior volume and electrically connected to said plurality of light emitting diodes.

3. The improved brake light assembly of claim 1, wherein said casing is formed from translucent plastic.

4. The improved brake light assembly of claim 3, wherein said translucent plastic is formed having a red color.

5. The improved brake light assembly of claim 1, wherein said plurality of light emitting diodes are adapted to emit a red colored light.

6. The improved brake light assembly of claim 1, wherein said casing further includes a reflecting film within an interior surface of said interior volume.

7. The improved brake light assembly of claim 1, wherein said casing is formed having dimensions including 15 inches in length, 1 inch in width, and 1 inch in depth.

8. The improved brake light assembly of claim 1, further comprising a connector member attached to said casing and is adapted to connect said improved brake light assembly to said rear window of said automobile.

9. The improved brake light assembly of claim 1, wherein said image displayed by said plurality of light emitting diodes forms the words “No Texting”.

10. The improved brake light assembly of claim 1, wherein said power source is adapted to supply power to said plurality of light emitting diodes when a brake pedal is pushed within said automobile.

11. A combination of an automobile and an improved brake light assembly for use with said automobile, said combination comprising:
an automobile including:
a rear window;
a brake pedal;
a power source; and
a power cable;
wherein said power cable is electrically connected between said power source and said brake pedal, and is adapted to be electrically connected to an improved brake light assembly; and
an improved brake light assembly for use with said automobile, comprising:
a casing including:
a front surface; and
a back surface;
wherein said front surface and said back surface form an interior volume; and wherein said casing is attached to said rear window of said automobile;
a plurality of light emitting diodes;
wherein said plurality of light emitting diodes are electrically connected to one another and located within said interior volume and are adapted to display an image through said front surface; and
wherein said power source supplies electrical power to said plurality of light emitting diodes.

12. The combination of claim 11, further comprising at least one resistor located within said interior volume and electrically connected to said plurality of light emitting diodes.

13. The combination of claim 11, wherein said casing is formed from translucent plastic.

14. The combination of claim 13, wherein said translucent plastic is formed having a red color.

15. The combination of claim 11, wherein said plurality of light emitting diodes are adapted to emit a red colored light.

16. The combination of claim 11, wherein said casing further includes a reflecting film within an interior surface of said interior volume.

17. The combination of claim 11, wherein said casing is formed having dimensions including 15 inches in length, 1 inch in width, and 1 inch in depth.

18. The combination of claim 11, further comprising a connector member attached to said casing and is adapted to connect said improved brake light assembly to said rear window of said automobile.

19. The combination of claim 11, wherein said image displayed by said plurality of light emitting diodes forms the words “No Texting”.

20. The combination of claim 11, wherein said power source is adapted to supply power to said plurality of light emitting diodes when a brake pedal is pushed within said automobile.
